(19) United States
(12) Patent Application Publication
(10) Pub. No.: US 2015/0206229 A1
(43) Pub. Date: Jul. 23, 2015

(54) APPARATUS AND METHOD FOR RENTING VEHICLE USING REVERSE AUCTION MECHANISM

(71) Applicant: ELECTRONICS AND TELECOMMUNICATIONS RESEARCH INSTITUTE, Daejeon (KR)

(72) Inventors: Shin Yuk KANG, Seoul (KR); Il Woo LEE, Daejeon (KR)

(21) Appl. No.: 14/594,539

(22) Filed: Jan. 12, 2015

(30) Foreign Application Priority Data
Jan. 22, 2014 (KR) 10-2014-0007797

(51) Int. Cl. G06Q 30/06; G06Q 30/08

(52) U.S. Cl. CPC G06Q 30/0645; G06Q 30/08

(57) ABSTRACT

Provided are an apparatus and method for renting a vehicle using a reverse auction mechanism. The apparatus includes an acquisition unit configured to acquire rental condition information input by a user intending to rent a vehicle, a collection unit configured to collect a plurality of pieces of rental bid information input by at least one renter intending to rent the vehicle, and a control unit configured to provide the user with a piece of rental bid information satisfying the rental condition information acquired by the acquisition unit among the collected plurality of pieces of rental bid information, and notify the renter that the provided piece of rental bid information has been selected when it is checked that the provided piece of rental bid information has been selected by the user.

### CROSS-REFERENCE TO RELATED APPLICATION

This application claims priority to and the benefit of Korean Patent Application No. 10-2014-0007797, filed on Jan. 22, 2014, the disclosure of which is incorporated herein by reference in its entirety.

### BACKGROUND

1. Field of the Invention

The present invention relates to an apparatus for renting a vehicle, and more particularly, to an apparatus and method for renting a vehicle using a reverse auction mechanism.

2. Discussion of Related Art

A vehicle rental service rents a vehicle to a user for a short or long period of time and is paid by a user according to the rental period and the type of the vehicle.

As an example, a user who uses such a vehicle rental service visits a branch office of a vehicle rental company, writes up a contract, pays the rental fee, and then receives a vehicle. In other words, a user visits a vehicle rental company's branch office, selects a desired vehicle type, writes up a contract, and then receives the corresponding vehicle.

As another example, a user accesses the reservation site of a vehicle rental company via the Internet, inputs desired vehicle rental conditions to find a vehicle satisfying the conditions, and makes a reservation. To rent a vehicle at a relatively low cost, a user inputs every desired vehicle rental condition to each reservation site of a plurality of vehicle rental companies, compares resultant vehicle rental fees with each other, make a reservation at a branch office of a vehicle rental company that rents the corresponding vehicle at the lowest price or a low price, and visits the branch office to rent the vehicle.

Meanwhile, to return a rental vehicle, a user visits a designated branch office. In other words, the user directly drives the rental vehicle to the designated branch office and returns the rental vehicle such that a vehicle rental contract ends.

Such an existing vehicle rental service is oriented not toward customers but toward vehicle rental companies and their branch offices. For example, an existing vehicle rental service involves a user accessing a web site of a vehicle rental company and visiting a branch office to receive a vehicle, and generally returning the rental vehicle to the branch office at which the rental vehicle has been received. Therefore, when a rental vehicle is necessary for a one-way route whose departure point and destination are different or a short-time and short-distance use (car sharing), no rental vehicle may be available, a rental fee may increase, or a user should return to the branch office at which the rental vehicle has been received and return the vehicle.

In addition, since vehicle rental fees of a plurality of vehicle rental companies differ from each other, a user may rent a vehicle at a relatively higher price under the same conditions (vehicle type, rental period, etc.), or do legwork to rent a vehicle at a lower rental fee. In other words, such an existing service method inconveniences users, resulting in a reduction in customer satisfaction.

### SUMMARY OF THE INVENTION

The present invention is directed to providing a technological method that makes it possible to provide a user-oriented vehicle rental service instead of a rental-company-oriented vehicle rental service.

According to an aspect of the present invention, there is provided an apparatus for renting a vehicle using a reverse auction mechanism, the apparatus including: an acquisition unit configured to acquire rental condition information input by a user intending to rent a vehicle; a collection unit configured to collect a plurality of pieces of rental bid information input by at least one renter intending to rent the vehicle; and a control unit configured to provide the user with a piece of rental bid information, among the collected plurality of pieces of rental bid information, satisfying the rental condition information acquired by the acquisition unit, and notify the renter that the provided piece of rental bid information has been selected when it is determined that the provided piece of rental bid information has been selected by the user.

Here, the collection unit may collect the plurality of pieces of rental bid information from a plurality of renters, respectively. When the piece of rental bid information satisfying the rental condition information is plural in number among the collected plurality of pieces of rental bid information, the collection unit may provide the user with the plurality of pieces of rental bid information satisfying the rental condition information. When one of the provided pieces of rental bid information is selected by the user, the collection unit may notify a renter having input the selected piece of rental bid information that the piece of rental bid information has been selected.

The rental condition information acquired by the acquisition unit may include at least one condition among a departure location, an arrival location, a departure time, a vehicle grade, a rental time, and a rental fee range. The piece of rental bid information provided to the user by the control unit may satisfy at least one of the conditions included in the rental condition information. The rental bid information collected by the collection unit may include at least one of pick-up locations, return locations, available rental times, rental fees according to rental time ranges, and vehicle grades.

In addition, the control unit may perform an authentication process of users and renters, and transmit and receive only the rental condition information input by the user authenticated through the authentication process and the plurality of pieces of rental bid information input by the renter authenticated through the authentication process.

Further, the vehicle may be an electric vehicle using electricity as a power source, and the pick-up locations and the return locations may be electric vehicle charging locations within a predetermined distance from the departure location and the arrival location of the rental condition information, respectively.

Also, when the rental condition information is acquired through the acquisition unit, the control unit may provide the acquired rental condition information to the renter, and when the piece of rental bid information satisfying the rental condition information is input from the renter in real time, the control unit may provide the piece of rental bid information input in real time to the user.

According to another aspect of the present invention, there is provided a method for a vehicle rental apparatus to rent a vehicle using a reverse auction mechanism, the method including: collecting a plurality of pieces of rental bid information input by at least one renter intending to rent a vehicle; acquiring rental condition information input by a user intending to rent the vehicle; providing the user with pieces of rental bid information, among the collected plurality of pieces of rental bid information, satisfying the acquired rental condition information; and notifying the renter that a provided piece of rental bid information has been selected when it is checked that the provided piece of rental bid information had been selected by the user.

Here, the collecting of the plurality of pieces of rental bid information may include collecting the plurality of pieces of rental bid information from a plurality of renters, respectively. When the pieces of rental bid information satisfying the acquired rental condition information are acquired from the plurality of renters, the providing of the user with the pieces of rental bid information satisfying the rental condition information may include providing the user with information on the renters having input the provided pieces of rental bid information as well. The notifying of the renter that the provided piece of rental bid information has been selected may include, when the provided piece of rental bid information is selected by the user, notifying a renter having input the selected piece of rental bid information that the piece of rental bid information has been selected.

Also, the acquiring of the rental condition information input by the user may include acquiring the rental condition information including at least one condition among a departure location, an arrival location, a departure time, a vehicle grade, a rental time, and a rental fee range. The providing of the user with the pieces of rental bid information satisfying the rental condition information may include providing the user with the pieces of rental bid information satisfying at least one of the conditions included in the rental condition information. The collecting of the plurality of pieces of rental bid information may include collecting the plurality of pieces of rental bid information including at least one piece of information among pick-up locations, return locations, available rental times, rental fees according to rental time ranges, and vehicle grades.

In addition, the method may further include performing an authentication process of users and renters. The collecting of the plurality of pieces of rental bid information may include collecting only the plurality of pieces of rental bid information input by the renter authenticated through the authentication process, and the acquiring of the rental condition information input by the user may include acquiring only the rental condition information input by the user authenticated through the authentication process.

Further, the method may further include: when the rental condition information is acquired, transferring the acquired rental condition information to the renter; and determining whether the pieces of rental bid information satisfying the transferred rental condition information are input in real time from the renter. The providing of the pieces of rental bid information satisfying the rental condition information to the user may include providing the user with the pieces of rental bid information checked to be input in real time.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a block diagram of an apparatus for renting a vehicle using a reverse auction mechanism according to an exemplary embodiment of the present invention; and

FIG. 2 is a flowchart of a method for a vehicle rental apparatus to rent a vehicle using a reverse auction mechanism according to an exemplary embodiment of the present invention.

FIG. 3 is a view illustrating a configuration of a computer device in which a method for renting a vehicle using a reverse auction mechanism according to an embodiment of the present invention is executed.

### DETAILED DESCRIPTION OF EXEMPLARY EMBODIMENTS

An apparatus for renting a vehicle using a reverse auction mechanism according to an aspect of the present invention includes an acquisition unit that acquires rental condition information input by a user intending to rent a vehicle, a collection unit that collects a plurality of pieces of rental bid information input by at least one renter intending to rent the vehicle, and a control unit that provides the user with a piece of rental bid information satisfying the rental condition information acquired by the acquisition unit among the collected plurality of pieces of rental bid information, and notifies the renter that the provided piece of rental bid information has been selected when it is determined that the provided piece of rental bid information has been selected by the user.

Here, the collection unit collects the plurality of pieces of rental bid information from a plurality of renters, respectively. When the piece of rental bid information satisfying the rental condition information is plural in number among the collected plurality of pieces of rental bid information, the collection unit provides the user with the plurality of pieces of rental bid information satisfying the rental condition information. When one of the provided pieces of rental bid information is selected by the user, the collection unit notifies a renter having input the selected piece of rental bid information that the piece of rental bid information has been selected.

The rental condition information acquired by the acquisition unit includes at least one condition among a departure location, an arrival location, a departure time, a vehicle grade, a rental time, and a rental fee range. The piece of rental bid information provided to the user by the control unit satisfies at least one of the conditions included in the rental condition information. The rental bid information collected by the collection unit includes at least one of pick-up locations, return locations, available rental times, rental fees according to rental time ranges, and vehicle grades.

In addition, the control unit performs an authentication process of users and renters, and transmits and receives only the rental condition information input by the user authenticated through the authentication process and the plurality of pieces of rental bid information input by the renters authenticated through the authentication process.

Further, the vehicle is an electric vehicle using electricity as a power source, and the pick-up locations and the return locations are electric vehicle charging locations within a predetermined distance from the departure location and the arrival location of the rental condition information, respectively.

Also, when the rental condition information is acquired through the acquisition unit, the control unit provides the acquired rental condition information to the renter, and when the piece of rental bid information satisfying the rental condition information is input by the renter in real time, the control unit provides the piece of rental bid information input in real time to the user.

A method for a vehicle rental apparatus to rent a vehicle using a reverse auction mechanism according to another aspect of the present invention includes collecting a plurality of pieces of rental bid information input by at least one renter intending to rent a vehicle, acquiring rental condition information input by a user intending to rent the vehicle, providing the user with pieces of rental bid information satisfying the acquired rental condition information among the collected plurality of pieces of rental bid information, and notifying the renter that a provided piece of rental bid information has been selected when it is checked that the provided piece of rental bid information has been selected by the user.

Here, the collecting of the plurality of pieces of rental bid information includes collecting the plurality of pieces of rental bid information from a plurality of renters, respectively. When the pieces of rental bid information satisfying the acquired rental condition information are acquired from the plurality of renters, the providing of the pieces of rental bid information satisfying the rental condition information to the user includes providing the user with information on the renters having input the provided pieces of rental bid information as well. When the provided piece of rental bid information is selected by the user, the notifying of the renter that the provided piece of rental bid information has been selected includes notifying a renter having input the selected piece of rental bid information that the piece of rental bid information has been selected.

Also, the acquiring of the rental condition information input by the user includes acquiring the rental condition information including at least one condition among a departure location, an arrival location, a departure time, a vehicle grade, a rental time, and a rental fee range. The providing of the pieces of rental bid information satisfying the rental condition information to the user includes providing the user with the pieces of rental bid information satisfying at least one of the conditions included in the rental condition information. The collecting of the plurality of pieces of rental bid information includes collecting the plurality of pieces of rental bid information including at least one piece of information among pick-up locations, return locations, available rental times, rental fees according to rental time ranges, and vehicle grades.

In addition, the method for a vehicle rental apparatus to rent a vehicle using a reverse auction mechanism further includes performing an authentication process of users and renters. The collecting of the plurality of pieces of rental bid information includes collecting only the plurality of pieces of rental bid information input by the renter authenticated through the authentication process, and the acquiring of the rental condition information input by the user includes acquiring only the rental condition information input by the user authenticated through the authentication process.

Further, the method for a vehicle rental apparatus to rent a vehicle using a reverse auction mechanism further includes, when the rental condition information is acquired, transferring the acquired rental condition information to the renter, and checking whether the pieces of rental bid information satisfying the transferred rental condition information are input in real time from the renter. The providing of the pieces of rental bid information satisfying the rental condition information to the user includes providing the user with the pieces of rental bid information checked to be input in real time.

Exemplary embodiments of the present invention will now be described more fully with reference to the accompanying drawings to clarify aspects, features, and advantages of the present invention. The invention may, however, be embodied in many different forms and should not be construed as being limited to the embodiments set forth herein. Rather, these embodiments are provided so that this disclosure will be through and complete, and will fully convey the concept of the invention to those of ordinary skill in the art. The present invention is defined by the appended claims.

Meanwhile, the terms used herein are for the purpose of describing exemplary embodiments only and are not intended to be limiting. As used herein, the singular forms “a,” “an,” and “the” are intended to include the plural forms as well, unless the context clearly indicates otherwise. It will be further understood that the terms “comprises” or “comprising,” when used in this specification, do not preclude the presence or addition of one or more components, steps, operations, and/or elements other than a mentioned component, step, operation, and/or element.

Hereinafter, exemplary embodiments of the present invention will be described in detail with reference to the accompanying drawings. Throughout the drawings, like numbers refer to like elements. Further, when it is determined that a detailed description of a known configuration or function related to the present invention may obscure the gist of the present invention, the detailed description will be omitted.

In the description of the present invention, a rental vehicle may be a general vehicle that uses fuel as a power source. Alternatively, a rental vehicle may be an electric vehicle that uses electricity as a power source. When a rental vehicle is an electric vehicle, there are many advantages in short-distance vehicle rental.

For example, a current vehicle rental system mainly rents general vehicles, and for convenience of vehicle management, most rental service companies employ a method of returning a vehicle to a location at which a user has received the vehicle. Accordingly, the user renting the vehicle bears an additional burden of refueling for both a short-distance use and a long-distance use, and may not be able to rent a vehicle due to a lack of rental vehicles in the case of a short-distance use that frequently involves different departure and arrival locations.

However, when a rental vehicle is an electric vehicle, a user renting such a vehicle uses parking lots with electric vehicle charging equipment as a vehicle reception location and return location, thus the user bears no additional burden of refueling even in the case of a short-distance use involving different departure and arrival locations. Also, a vehicle renter may rent the vehicle at a low price without burdening a customer (user) with fueling, and may charge the vehicle using charging equipment prepared at a pick-up location and a return location while keeping the rental vehicle.

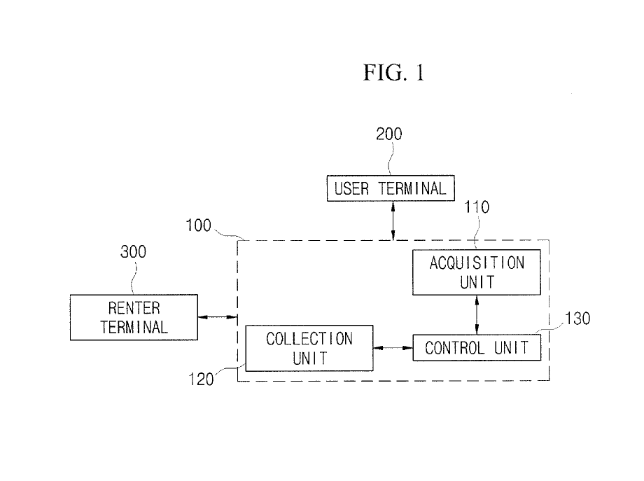

FIG. 1 is a block diagram of an apparatus for renting a vehicle using a reverse auction mechanism according to an exemplary embodiment of the present invention. As shown in the drawing, an apparatus 100 for renting a vehicle using a reverse auction mechanism includes an acquisition unit 110, a collection unit 120, and a control unit 130.

The acquisition unit 110 acquires rental condition information input by a user who intends to rent a vehicle. Here, the vehicle rental condition information includes at least one condition among a departure location and time at which the user wants to receive the rental vehicle, an arrival location at which the user wants to return the rental vehicle, a vehicle rental time (duration), a vehicle grade, and an expected vehicle rental fee range. For example, the acquisition unit 110 acquires the rental condition information from a user terminal of the user who intends to rent the vehicle.

Here, the user terminal 200 is a user interface that may receive an input of the user and provide information to the user. In other words, the user terminal 200 is a terminal for inputting rental condition information of a vehicle wanted by a user intending to rent the vehicle, and the user may input at least one condition among conditions included in the rental condition information to the user terminal 200. At this time, the user may necessarily input a departure location, a departure time, and an arrival location among conditions included in the rental condition information. Also, the user terminal 200 may perform a user authentication operation, and only a user authenticated through the authentication operation is able to input rental condition information.

As an example, the user terminal 200 is a portable terminal that may be carried by a user, and may be the user's mobile communication terminal (e.g., smart phone). In the user terminal 200, an application program for renting a vehicle is installed, and the user may execute the application program and input the rental condition information of a vehicle. When the rental condition information is input by the user, the user terminal 200 may transfer the rental condition information to the acquisition unit 110 of the vehicle rental apparatus 100.

As another example, the user terminal 200 is a computer device to which a user may input vehicle rental condition information. For example, the user terminal 200 is a means for accessing a web site of the vehicle rental apparatus 100 for renting a vehicle by manipulation of the user such that the user may input the vehicle rental condition information. Alternatively, a program for renting a vehicle is installed in the user terminal 200, that is, the computer device, and when the program is executed by the user and rental condition information is input, the user terminal 200 may transmit the inputted rental condition information to the acquisition unit 110 of the vehicle rental apparatus 100.

The user terminal 200 may transmit the inputted vehicle rental condition information to the acquisition unit 110 of the vehicle rental apparatus 100 via wireless communication. To this end, the user terminal 200 may have a mobile communication module that supports a mobile communication system, such as a third generation (3G) mobile communication system or a long term evolution (LTE) mobile communication system, or a wireless communication system, such as a wireless fidelity (WiFi) communication system, and may exchange information with the vehicle rental apparatus 100 through at least one communication module via wireless communication. In other words, the acquisition unit 110 may acquire rental condition information through a communication module that supports the same wireless communication system as the user terminal 200.

In addition, to receive an input of a user, the user terminal 200 includes an input device, such as buttons, a touchpad, or a keyboard. The user terminal 200 includes a screen output (display) device, such as a liquid crystal display (LCD) device, to provide the user with information (e.g., rental bid information input by a renter) received from the control unit 130 of the vehicle rental apparatus 100, which will be described later.

The collection unit 120 collects a plurality of pieces of rental bid information input by renters intending to rent vehicles, and may be a server device. Here, the rental bid information includes at least one piece of information among pick-up locations at which the renters intend to hand over vehicles, return locations at which the renters intend to get the vehicles back, rental fees according to available vehicle rental time ranges, and rental vehicle grades. Here, the pick-up locations and the return locations may be vehicle storage units in which rental companies keep rental vehicles, or branch offices of the rental companies. Meanwhile, when a rental vehicle is an electric vehicle which uses electricity as a power source, a pick-up location and a return location may be electric vehicle charging stations at which it is possible to charge electric vehicles, or parting lots with vehicle charging equipment.

For example, the collection unit 120 collects rental bid information from at least one renter terminal 300 used by at least one renter who intends to rent a vehicle. Here, the renter terminal 300 is used, for a renter (e.g., a vehicle rental company and affiliated staff members) who intends to rent a vehicle, to input rental bid information of the vehicle, and the renter may input at least one among pieces of information included in the rental bid information to the renter terminal 300. Also, the renter terminal 300 may perform a renter authentication operation, and only a renter authenticated through the authentication operation is able to input rental bid information.

A renter may necessarily input a pick-up location, a return location, and rental fees according to available vehicle rental time ranges. At this time, if the renter needs to move rental vehicles from a region crowded with a large number of rental vehicles managed/owned by the renter to another region with a small number of rental vehicles, the renter may input low renter fees, thereby leading users to rent vehicles and improving efficiency in managing vehicles. Likewise, a vehicle rental from a region with a small number of rental vehicles to another region crowded with a large number of rental vehicles may be a burden on a renter. Therefore, by inputting high rental fees in such a case, the renter may cause users to rent a vehicle for such a use only in the case of necessity, thereby facilitating management of vehicles. In this way, rental bid information that is input to the renter terminal 300 to prevent a concentration of vehicles in a specific region, is able to be frequently modified or removed by the renter.

As an example, the renter terminal 300 is a computer device to which a renter may input rental bid information of a vehicle. For example, the renter terminal 300 accesses a web site of the vehicle rental apparatus 100 for renting a vehicle by manipulation of the renter such that the renter may input the vehicle rental bid information. Alternatively, a program for renting a vehicle is installed in the renter terminal 300, that is, the computer device, and when the program is executed by the renter and the rental bid information is input, the renter terminal 300 may transmit the input rental bid information to the vehicle rental apparatus 100.

As another example, the renter terminal 300 is a portable terminal that may be carried by a renter, and may be the renter's mobile communication terminal (e.g., smart phone). In the renter terminal 300, an application program for renting a vehicle may be installed, and the renter may execute the application program and input rental bid information of a vehicle. When rental bid information is input by the renter, the renter terminal 300 may transfer the rental bid information to the vehicle rental apparatus 100.

The renter terminal 300 may transmit input vehicle rental bid information to the vehicle rental apparatus 100 via wireless communication. To this end, the renter terminal 300 may have a mobile communication module that supports a wireless communication system, such as a WiFi communication system, or a mobile communication system, such as a 3G mobile communication system or an LTE mobile communication system, and may exchange information with the vehicle rental apparatus 100 through at least one communication module via wireless communication. In other words, the collection unit 120 may collect rental bid information through a communication module that supports the same wireless communication system as the communication module installed in the renter terminal 300, from the renter terminal 300.

In addition, to receive an input of a user, the renter terminal 300 includes an input device, such as buttons, a touchpad, or a keyboard. Also, the renter terminal 300 includes a screen output (display) device, such as an LCD device, to receive rental condition information input by a user from the control unit 130 of the vehicle rental apparatus 100, which will be described later, and provide the rental condition information to the renter, and may also receive and provide selection information according to whether or not the user has made a selection to the renter.

The renter may input rental bid information for each of a plurality of vehicles owned/managed by the renter to the renter terminal 300. Also, when rental condition information input by a user is received by the renter terminal 300, the renter may input rental bid information according to the received rental condition information.

A plurality of pieces of rental bid information input to the renter terminal 300 by the renter may be collected by the collection unit 120. In other words, the collection unit 120 may collect a plurality of pieces of rental bid information from each of renter terminals 300 respectively owned by a plurality of renters, and the collected plurality of pieces of rental bid information may be uploaded to a server and stored in a database. The stored plurality of pieces of rental bid information may be searched by a user, grouped according to a range of a rental condition wanted by the user, and provided to the user.

The control unit 130 controls overall operation of the vehicle rental apparatus 100, and may be a control module. The control unit 130 provides the user with pieces of rental bid information satisfying rental condition information of the user acquired by the acquisition unit 110 among the plurality of pieces of rental bid information collected by the collection unit 120 by transmitting the pieces of rental bid information to the user terminal 200. When it is checked that one piece of rental bid information is selected by the user, the control unit 130 notifies a renter that the piece of rental bid information has been selected by transmitting selection information to a renter terminal 300.

For example, the control unit 130 receives rental condition information input by the user from the user terminal 200 through the acquisition unit 110, and checks conditions included in the received rental condition information. At this time, the control unit 130 may necessarily check a departure location, an arrival location, and a rental time among the conditions included in the received rental condition information.

The control unit 130 provides the user with pieces of rental bid information satisfying at least one of the checked conditions of the rental condition information among the plurality of pieces of rental bid information collected by the collection unit 120 by transmitting the pieces of rental bid information to the user terminal 200. Also, since the plurality of pieces of rental bid information have been collected from the plurality of renters, the control unit 130 may also provide the user with information on the renters (e.g., vehicle rental company information) having input the pieces of rental bid information provided to the user by transmitting the renter information to the user terminal 200.

In addition, when the rental condition information input by the user is received from the user terminal 200 through the acquisition unit 110, the control unit 130 may notify the renters of the received rental condition information by transmitting the rental condition information to the renter terminals 300. In this case, the renters may check the rental condition information of the user and input rental bid information satisfying the rental condition information through the renter terminals 300, and the collection unit 120 may collect the rental bid information input by the renters in real time. The control unit 130 checks the piece of rental bid information collected in real time. When the rental bid information satisfies the rental condition information of the user, the control unit 130 may transmit not only previously collected rental bid information satisfying the rental condition information but also the rental bid information collected in real time to the user terminal 200.

There may be a plurality of pieces of rental bid information satisfying the rental condition information, and the control unit 130 may provide the user with the pieces of rental bid information satisfying the rental condition information by transmitting the pieces of rental bid information satisfying the rental condition information to the user terminal 200. Further, the control unit 130 may also transmit rental bid information within a predetermined error range from conditions included in the rental condition information to the user terminal 200.

As an example, the control unit 130 may transmit not only rental bid information including a pick-up location and a return location that are the same as a departure location and an arrival location included in the received rental condition information but also rental bid information including a pick-up location and a return location within a predetermined distance (e.g., 500 m) from the departure location and the arrival location to the user terminal 200.

As another example, the control unit 130 may transmit not only rental bid information including an available rental time the same as a rental time included in the received rental condition information but also rental bid information including an available rental time that is within a predetermined time (e.g., one hour) before and after the rental time to the user terminal 200.

Likewise, rental bid information including a vehicle type and a rental fee within a predetermined error range from a vehicle type and a rental fee included in the rental condition information may also be transmitted to the user terminal 200. The predetermined error range may be determined by the user when the user inputs the rental condition information to the user terminal 200.

The control unit 130 checks which one of pieces of rental bid information provided to the user is selected by the user. For example, when any one of the pieces of rental bid information is selected by manipulation of the user from among the pieces of rental bid information provided through the user terminal 200, the user terminal 200 transfers selection information indicating which one of the pieces of rental bid information has been selected to the control unit 130, such that the control unit 130 may check which one of the pieces of rental bid information has been selected by the user. In other words, the user may search the pieces of rental bid information output by the user terminal 200 for information on rentable vehicles, and perform a reservation process for renting a vehicle by selecting a desired one of the pieces of rental bid information.

When it is checked through the selection information received from the user terminal 200 that one of the pieces of rental bid information has been selected, the control unit 130 transmits notification information indicating that the piece of rental bid information has been selected by the user to a renter terminal 300. In other words, a renter may know that the piece of rental bid information input by the renter has been selected by the user by checking the notification information through the renter terminal 300, and perform a process for vehicle rental. Since the pieces of rental bid information provided to the user may have been input by a plurality of different renters, the control unit 130 may check renter information corresponding to the piece of rental bid information selected by the user, and provide the renter with the notification by transmitting the notification information to the renter terminal 300 of the renter.

As described above, according to an exemplary embodiment of the present invention, a user intending to rent a vehicle is provided with various pieces of rental bid information satisfying a rental vehicle condition input by himself or herself, and compares the pieces of rental bid information with each other. Therefore, the user may have a wide selection range and rent an appropriate vehicle at low cost, and a renter intending to rent vehicles may flexibly provide rental bid information according to running of a plurality of rental vehicles managed by the renter.

In addition, according to another exemplary embodiment of the present invention, an electric vehicle is used as a rental vehicle, and thus a user's burden of refueling is reduced in the case of a short-distance use that frequently involves a departure point and a destination different from each other.

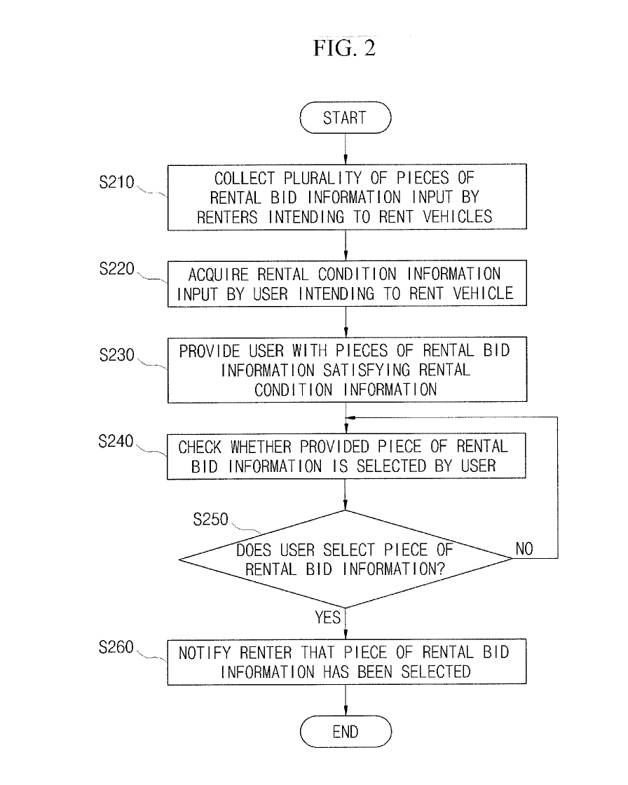

FIG. 2 is a flowchart of a method for a vehicle rental apparatus to rent a vehicle using a reverse auction mechanism according to an exemplary embodiment of the present invention.

In step 210, the vehicle rental apparatus 100 collects a plurality of pieces of rental bid information input by a renter intending to rent vehicles. For example, the vehicle rental apparatus 100 may collect a plurality of pieces of rental bid information respectively input by a plurality of renters intending to rent vehicles. Here, the plurality of pieces of rental bid information include at least one piece of information among pick-up locations at which the renters intend to hand over vehicles, return locations at which the renters intend to get the vehicles back, rental fees according to available vehicle rental time ranges, and rental vehicle grades. The pick-up locations and the return locations may be a plurality of vehicle storage units in which vehicle rental companies keep rental vehicles, or a plurality of branch offices of the rental companies. When a rental vehicle is an electric vehicle that uses electricity as a power source, a pick-up location and a return location may be electric vehicle charging stations at which it is possible to charge electric vehicles, or parting lots with vehicle charging equipment.

In other words, a renter may input at least one piece of information among conditions included in rental bid information to renter terminals 300. At this time, the renter may necessarily input a pick-up location, a return location, and rental fees according to rental time ranges. Also, the renter terminals 300 may perform a renter authentication operation, and only renters authenticated through the authentication operation are able to input rental bid information.

In step 220, the vehicle rental apparatus 100 acquires rental condition information input by a user intending to rent a vehicle. For example, the vehicle rental apparatus 100 may acquire rental condition information input to the user terminal 200 used by a user intending to rent a vehicle. Here, the vehicle rental condition information includes at least one condition among a departure location and time at which the user wants to receive the rental vehicle, an arrival location at which the user wants to return the rental vehicle, a vehicle rental time (duration), a vehicle grade, and an expected vehicle rental fee range.

In other words, the user may input at least one of conditions included in rental condition information to the user terminal 200. At this time, the user may necessarily input a departure location, an arrival location, a vehicle rental time (departure time and arrival time), and a desired price range among conditions included in rental condition information. Also, the user terminal 200 may perform a user authentication operation, and only a user authenticated through the authentication operation is able to input rental condition information.

In step 230, the vehicle rental apparatus 100 provides pieces of rental bid information satisfying the acquired rental condition information to the user. For example, the vehicle rental apparatus 100 provides the user with pieces of rental bid information satisfying the rental condition information of the user acquired in step 200 among the plurality of pieces of rental bid information collected in step 210 by transmitting the pieces of rental bid information to the user terminal 200. At this time, the vehicle rental apparatus 100 checks conditions included in the rental condition information acquired in step 220, and may necessarily check the departure location, the arrival location, the vehicle rental time, and a rental fee.

The vehicle rental apparatus 100 provides the user with pieces of rental bid information satisfying at least one of the checked conditions included in the rental condition information by transmitting the pieces of rental bid information to the user terminal 200. Also, since the plurality of pieces of rental bid information have been collected from the plurality of renters, the vehicle rental apparatus 100 may also provide the user with information on the renters (e.g., vehicle rental company information) having input the pieces of rental bid information provided to the user by transmitting the renter information to the user terminal 200.

Alternatively, when the rental condition information input by the user is received, the vehicle rental apparatus 100 may notify the renters of the received rental condition information by transmitting the rental condition information to the renter terminals 300. In this case, the renters may check the rental condition information of the user and input rental bid information satisfying the rental condition information through the renter terminals 300, and the vehicle rental apparatus 100 may collect the rental bid information input by the renters in real time. The vehicle rental apparatus 100 checks the piece of rental bid information collected in real time. When the rental bid information satisfies the rental condition information of the user, the vehicle rental apparatus 100 may provide the user not only with previously collected rental bid information satisfying the rental condition information but also with the rental bid information collected in real time by transmitting the previously collected rental bid information and the rental bid information collected in real time to the user terminal 200.

In step 240, the vehicle rental apparatus 100 checks which one of the pieces of rental bid information provided to the user is selected by the user. For example, when any one of the pieces of rental bid information is selected by manipulation of the user from among the pieces of rental bid information provided through the user terminal 200, the user terminal 200 transfers selection information indicating which one of the pieces of rental bid information has been selected to the vehicle rental apparatus 100. Through the selection information transferred from the user terminal 200, the vehicle rental apparatus 100 may check which one of the pieces of rental bid information has been selected by the user. In other words, the user may search the pieces of rental bid information output by the user terminal 200 for information on rentable vehicles, and perform a reservation process for renting a vehicle by selecting desired one of the pieces of rental bid information.

When it is checked in step 240 that the one of the pieces of rental bid information has been selected, the process proceeds from step 250 to step 260. In step 260, the vehicle rental apparatus 100 notifies the corresponding renter that the piece of rental bid information has been selected by the user. For example, when it is checked through the selection information received from the user terminal 200 that the one of the pieces of rental bid information has been selected, the vehicle rental apparatus 100 transmits notification information indicating that the piece of rental bid information has been selected by the user to a renter terminal 300. In other words, the corresponding renter may know that the piece of rental bid information input by the renter has been selected by the user by checking the notification information through the renter terminal 300, and perform a process for vehicle rental.

Since the pieces of rental bid information provided to the user may have been input by a plurality of different renters, the vehicle rental apparatus 100 may check renter information corresponding to the piece of rental bid information selected by the user, and provide the renter with the notification by transmitting the notification information to the renter terminal 300 of the renter.

As described above, according to an exemplary embodiment of the present invention, a user intending to rent a vehicle is provided with various pieces of rental bid information satisfying a rental vehicle condition input by himself or herself, and compares the pieces of rental bid information with each other. Therefore, the user may have a wide selection range and rent an appropriate vehicle at low cost, and a renter intending to rent vehicles may flexibly provide rental bid information according to running of a plurality of rental vehicles managed by the renter.

In addition, according to another exemplary embodiment of the present invention, an electric vehicle is used as a rental vehicle, and thus a user's burden of refueling is reduced in the case of a short-distance use that frequently involves a departure point and a destination different from each other.

Each block of the appended block diagram and combinations of steps of the appended flowchart may be implemented by computer program instructions. These computer program instructions may be installed in a processor of a general-use computer, a special-use computer, or other programmable data processing apparatuses, such that the instructions, which are executed by the processor of the computer or the other programmable data processing apparatuses, create a means for implementing functions described in connection with each block of the block diagram or each step of the flowchart. To implement functions using a specific method, these computer program instructions may also be stored in a computer-usable or computer-readable memory that may instruct a computer or other programmable data processing apparatuses. Therefore, instructions stored in the computer-usable or computer-readable memory may also create a product including an instructional means for performing functions described in connection with each block of the block diagram or each step of the flowchart. Since it is possible to install the computer program instructions in a computer or other programmable data processing apparatuses, a series of operation steps may be performed on the computer or other programmable data processing apparatuses to produce a computer-implemented process such that the instructions, which are executed on the computer or the other programmable data processing apparatuses, may provide processes for implementing functions described in connection with each block of the block diagram or each step of the flowchart.

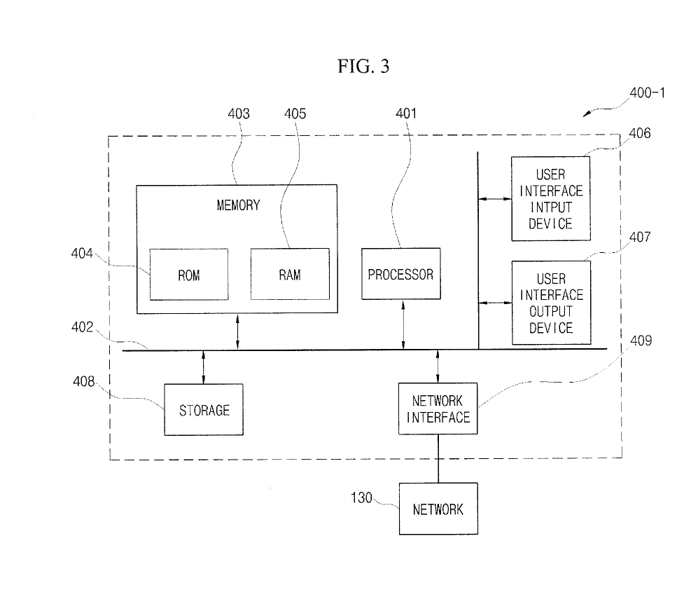

A method for renting a vehicle using a reverse auction mechanism according to an embodiment of the present invention may be implemented in a computer system, e.g., as a computer readable medium. As shown in FIG. 3, a computer system 400 may include one or more of a processor 401, a memory 403, a user input device 406, a user output device 407, and a storage 408, each of which communicates through a bus 402. The computer system 400 may also include a network interface 409 that is coupled to a network 410. The processor 401 may be a central processing unit (CPU) or a semiconductor device that executes processing instructions stored in the memory 403 and/or the storage 408. The memory 403 and the storage 408 may include various forms of volatile or non-volatile storage media. For example, the memory may include a read-only memory (ROM) 404 and a random access memory (RAM) 405.

Accordingly, a method for renting a vehicle using a reverse auction mechanism according to an embodiment of the present invention may be implemented as a computer implemented method or as a non-transitory computer readable medium with computer executable instructions stored thereon. In an embodiment, when executed by the processor, the computer readable instructions may perform a method according to at least one aspect of the invention.

It will be apparent to those skilled in the art that various modifications can be made to the above-described exemplary embodiments of the present invention without departing from the spirit or scope of the invention. Thus, it is intended that the present invention cover all such modifications provided they come within the scope of the appended claims and their equivalents.

What is claimed is:

1. An apparatus for renting a vehicle using a reverse auction mechanism, the apparatus comprising:
an acquisition unit configured to acquire rental condition information input by a user intending to rent a vehicle;
a collection unit configured to collect a plurality of pieces of rental bid information input by at least one renter intending to rent the vehicle; and
a control unit configured to provide the user with a piece of rental bid information satisfying the rental condition information acquired by the acquisition unit among the collected plurality of pieces of rental bid information, and notify the renter that the provided piece of rental bid information has been selected when it is determined that the provided piece of rental bid information has been selected by the user.

2. The apparatus of claim 1, wherein the collection unit collects the plurality of pieces of rental bid information from a plurality of renters, respectively.

3. The apparatus of claim 2, wherein, when the piece of rental bid information satisfying the rental condition information is plural in number among the collected plurality of pieces of rental bid information, the collection unit provides the user with the plurality of pieces of rental bid information satisfying the rental condition information, and
when one of the provided pieces of rental bid information is selected by the user, the collection unit notifies a renter having input the selected piece of rental bid information that the piece of rental bid information has been selected.

4. The apparatus of claim 1, wherein the rental condition information acquired by the acquisition unit includes at least one condition among a departure location, an arrival location, a departure time, a vehicle grade, a rental time, and a rental fee range.

5. The apparatus of claim 4, wherein the piece of rental bid information provided to the user by the control unit satisfies at least one of the conditions included in the rental condition information.

6. The apparatus of claim 4, wherein the plurality of pieces of rental bid information collected by the collection unit include at least one of pick-up locations, return locations, available rental times, rental fees, and vehicle grades.

7. The apparatus of claim 1, wherein the control unit performs an authentication process of users and renters, and transmits and receives only the rental condition information input by the user authenticated through the authentication process and the plurality of pieces of rental bid information input by the renters authenticated through the authentication process.

8. The apparatus of claim 6, wherein the vehicle is an electric vehicle using electricity as a power source, and the pick-up locations and the return locations are electric vehicle charging locations within a predetermined distance from the departure location and the arrival location of the rental condition information, respectively.

9. The apparatus of claim 1, wherein, when the rental condition information is acquired through the acquisition unit, the control unit provides the acquired rental condition information to the renter, and
when the piece of rental bid information satisfying the rental condition information is input from the renter in real time, the control unit provides the piece of rental bid information input in real time to the user.

10. A method for a vehicle rental apparatus to rent a vehicle using a reverse auction mechanism, the method comprising:
collecting a plurality of pieces of rental bid information input by at least one renter intending to rent a vehicle;
acquiring rental condition information input by a user intending to rent the vehicle;
providing the user with pieces of rental bid information, among the collected plurality of pieces of rental bid information, satisfying the acquired rental condition information; and
notifying the renter that a provided piece of rental bid information has been selected when it is checked that the provided piece of rental bid information has been selected by the user.

11. The method of claim 10, wherein the collecting of the plurality of pieces of rental bid information includes collecting the plurality of pieces of rental bid information from a plurality of renters, respectively.

12. The method of claim 11, wherein, when the pieces of rental bid information satisfying the acquired rental condition information are acquired from the plurality of renters, the providing of the user with the pieces of rental bid information satisfying the rental condition information, includes providing the user with information on the renters having input the provided pieces of rental bid information as well.

13. The method of claim 12, wherein the notifying of the renter that the provided piece of rental bid information has been selected includes, when the provided piece of rental bid information is selected by the user, notifying a renter having input the selected piece of rental bid information that the piece of rental bid information has been selected.

14. The method of claim 10, wherein the acquiring of the rental condition information input by the user includes acquiring the rental condition information including at least one condition among a departure location, an arrival location, a departure time, a vehicle grade, a rental duration, and a rental fee range.

15. The method of claim 14, wherein the providing of the user with the pieces of rental bid information satisfying the rental condition information, includes providing the user with the pieces of rental bid information satisfying at least one of the conditions included in the rental condition information.

16. The method of claim 10, wherein the collecting of the plurality of pieces of rental bid information includes collecting the plurality of pieces of rental bid information including at least one piece of information among pick-up locations, return locations, available rental times, rental fees according to rental time ranges, and vehicle grades.

17. The method of claim 10, further comprising performing an authentication process of users and renters,
wherein the collecting of the plurality of pieces of rental bid information includes collecting only the plurality of pieces of rental bid information input by the renter authenticated through the authentication process, and
the acquiring of the rental condition information input by the user includes acquiring only the rental condition information input by the user authenticated through the authentication process.

18. The method of claim 10, further comprising:
when the rental condition information is acquired, transferring the acquired rental condition information to the renter; and
determining whether the pieces of rental bid information satisfying the transferred rental condition information are input in real time from the renter,
wherein the providing of the pieces of rental bid information satisfying the rental condition information to the user includes providing the user with the pieces of rental bid information checked to be input in real time.
